(19) United States
(12) Patent Application Publication
(10) Pub. No.: US 2012/0095673 A1
(43) Pub. Date: Apr. 19, 2012

(54) APPARATUS AND METHOD FOR PROVIDING DRIVING INFORMATION FOR VEHICLES BASED ON HIGH SPEED MOVEMENT LONG DISTANCE IMPUSE RADIO ULTRA WIDEBAND

(75) Inventors: Youngwoo CHOI, Daejeon-si (KR); Seong Yun CHO, Daejeon-si (KR); Sang Joon PARK, Daejeon-si (KR); Yoo Seung SONG, Daejeon-si (KR)

(73) Assignee: Electronics and Telecommunications Research Institute, Daejeon-si (KR)

(21) Appl. No.: 13/272,634

(22) Filed: Oct. 13, 2011

(30) Foreign Application Priority Data
Oct. 13, 2010 (KR) 10-2010-0099690
Mar. 4, 2011 (KR) 10-2011-0019221

(51) Int. Cl. G06G 7/78; G06F 19/00

(52) U.S. Cl. 701/300

(57) ABSTRACT

An apparatus for providing driving information for a vehicle based on high speed movement long distance impulse radio-ultra wideband (IR-UWB) is provided. The apparatus includes an IR-UWB module configured to generate a packet based on high speed movement long distance IR-UWB, transmit the generated packet, and interpret a received packet and a controller operationally coupled to the IR-UWB module. The controller is configured for the step of estimating a distance between an own vehicle and a different vehicle, estimating a relative location of the own vehicle with respect to the different vehicle based on the distance and generating driving information including the distance and the relative location.

### CROSS-REFERENCE TO RELATED APPLICATIONS

This application claims the benefit of priority of Korean Patent Applications No. 10-2010-0099690 filed on Oct. 13, 2010 and 10-2011-0019221 filed on Mar. 4, 2011, all of which are incorporated by reference in their entirety herein

### BACKGROUND OF THE INVENTION

1. Field of the Invention

The present invention relates to an apparatus and method for providing a vehicle driving information and, more particularly, to an apparatus and method for providing vehicle driving information based on high speed movement long distance impulse radio-ultra wideband (IR-UWB).

2. Related Art

Recently, techniques that acquire information regarding an operation environment while a vehicle is driving is driving has been developed. Among the techniques devised for providing security and stability while a vehicle is driving is an apparatus for providing vehicle driving information. The apparatus for providing vehicle driving information primarily aims at preventing an accident by estimating the distance between vehicles on a route.

The existing vehicle driving information apparatus has been already generalized, but it is disadvantageous in terms of cost. Thus, it is substantially undesirable to apply the high-priced vehicle driving information providing apparatus to a general vehicle.

A vehicle radar, one of the existing vehicle driving information providing apparatuses, provides an accurate value in estimating the distance between vehicles. However, since data communication between vehicles is not possible, communication-based inter-vehicle information cannot be provided. If driving information were received from a different vehicle in operation and directly used and the corresponding driving information were transmitted to a different vehicle that follows, a safer driving could be guaranteed.

Thus, in order to guarantee safer vehicle driving, a vehicle driving information providing apparatus which is advantageous in terms of cost, capable of precisely measuring the distance between vehicles and a location of vehicles, and transferred driving information to a different vehicle is required.

### SUMMARY OF THE INVENTION

It is an object of the present invention to provide an apparatus and method for providing vehicle driving information based on a high speed movement long distance impulse radio-ultra wideband (IR-UWB) technique.

In an aspect, an apparatus for providing driving information for a vehicle based on high speed movement long distance impulse radio-ultra wideband (IR-UWB) is provided. The apparatus includes an IR-UWB module configured to generate a packet based on high speed movement long distance IR-UWB, transmit the generated packet, and interpret a received packet and a controller operationally coupled to the IR-UWB module. The controller is configured for the step of estimating a distance between an own vehicle and a different vehicle, estimating a relative location of the own vehicle with respect to the different vehicle based on the distance and generating driving information including the distance and the relative location.

The controller may be configured for further step of transmitting the driving information to a third vehicle.

The apparatus further includes an image sensor is operationally coupled to the controller. The image sensor is configured for the step of measuring location of the different vehicle when the different vehicle exists within a predetermined detection range.

The controller is configured for further step of compensating for the distance based on location measurement results of the different vehicle when the location measurement results are received from the image sensor. The driving information may include the compensated distance and the relative location.

The apparatus further may include a display unit operationally coupled with the controller. The display unit may be configured to visually display the driving information transferred from the controller.

The step of estimating of the distance may include transmitting a first packet to the different vehicle, receiving a second packet from the different vehicle in response to the first packet and calculating the distance based on a time taken for the first packet to reach the different vehicle after the first packet was transmitted.

The apparatus for providing driving information for a vehicle may be installed on a license plate.

In another aspect, a method for providing driving information for a vehicle is provided. The method includes estimating a distance between an own vehicle and a different vehicle, estimating a relative location of the own vehicle with respect to the different vehicle based on the distance and generating driving information including the distance and the relative location. The distance is estimated based on a packet transmission and reception based on high speed movement long distance impulse radio-ultra wideband (IR-UWB).

The method may further include transmitting the driving information to a third vehicle.

The method may further include, when the different vehicle exists within a predetermined range, measuring a location of the different vehicle and compensating for the distance based on the location of the different vehicle. The driving information may include the distance and the relative location.

The estimating of the distance may include transmitting a first packet to the different vehicle, receiving a second packet from the different vehicle in response to the first packet, and calculating the distance based on a time taken for the first packet to reach the different vehicle after the first packet was transmitted.

The method may further include visually displaying the driving information.

### BRIEF DESCRIPTION OF THE DRAWINGS

The above and other objects and features of the present invention will become apparent from the following description of preferred embodiments given in conjunction with the accompanying drawings, in which:

FIG. 1 is a view showing an example of a location estimation based on an IR-UWB provided in IEEE 802.15.4a standard.

FIG. 2 is view showing a concept of high speed movement long distance impulse radio-ultra wideband (IR-UWB) applicable to an embodiment of the present invention.

FIG. 3 is a view showing an example of a method for estimating a distance according to an embodiment of the present invention.

FIG. 4 is a schematic block diagram of an apparatus for providing vehicle driving information based on IR-UWB according to an embodiment of the present invention.

FIG. 5 is a view showing a multi-hop transmission performed according to an embodiment of the present invention.

FIG. 6 is a view showing an example of implementation of an apparatus for providing vehicle driving information according to an embodiment of the present invention.

### DESCRIPTION OF EXEMPLARY EMBODIMENTS

Hereinafter, exemplary embodiments will be described in detail with reference to the accompanying drawings so that they can be easily practiced by those skilled in the art to which the present invention pertains. This invention may, however, be embodied in many different forms and should not be construed as being limited to the embodiments set forth herein. In order to clarify the present invention, parts irrespective of description will be omitted, and similar reference numerals are used for the similar parts throughout the specification.

Throughout the specification and claims, unless explicitly described to the contrary, the word “comprise” and variations such as “comprises” or “comprising”, will be understood to imply the inclusion of stated elements but not the exclusion of any other elements. Term of “ . . . part” described in the specification refers to a unit for processing at least one function or operation, and it may be implemented by hardware, software, or a combination of hardware and software.

IR-UWB (Impulse Radio—Ultra Wideband) has been under standardization by IEEE (Institute of Electrical and Electronics Engineering), a standardization organization, and its standardization was concluded as IEEE 802.15.4a standard in 2007 at the first stage of the work.

IR-UWB, which is a low speed location-based network standard using a UWB pulse, is a technical standard for providing a function of precisely estimating a distance and a location as a basis of a currently emerging ubiquitous environment. IR-UWB proposed by IEEE 802.15.4a provides precision of an error range of 1 m or smaller in estimating a distance. A frequency band based on radio communication uses ultra-wideband (UWB) of 3.1 GHz to 10.6 GHz and guarantees a distance within 30 m as a system operation range.

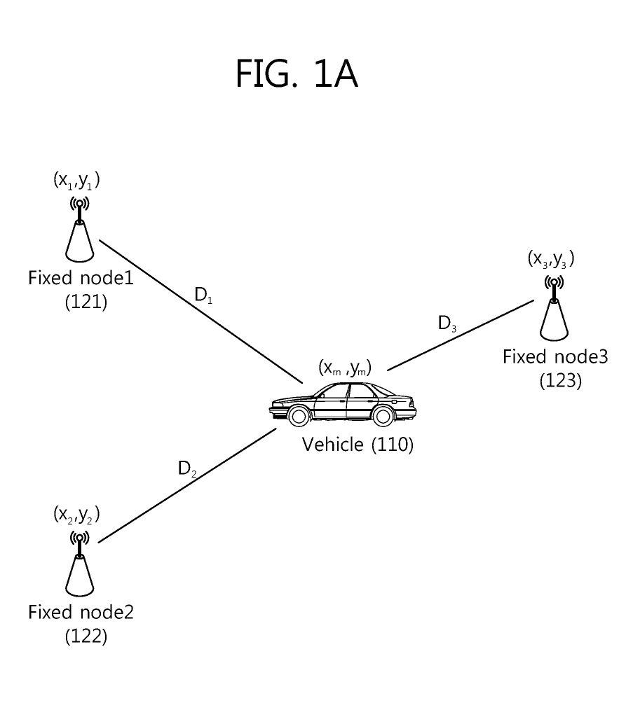

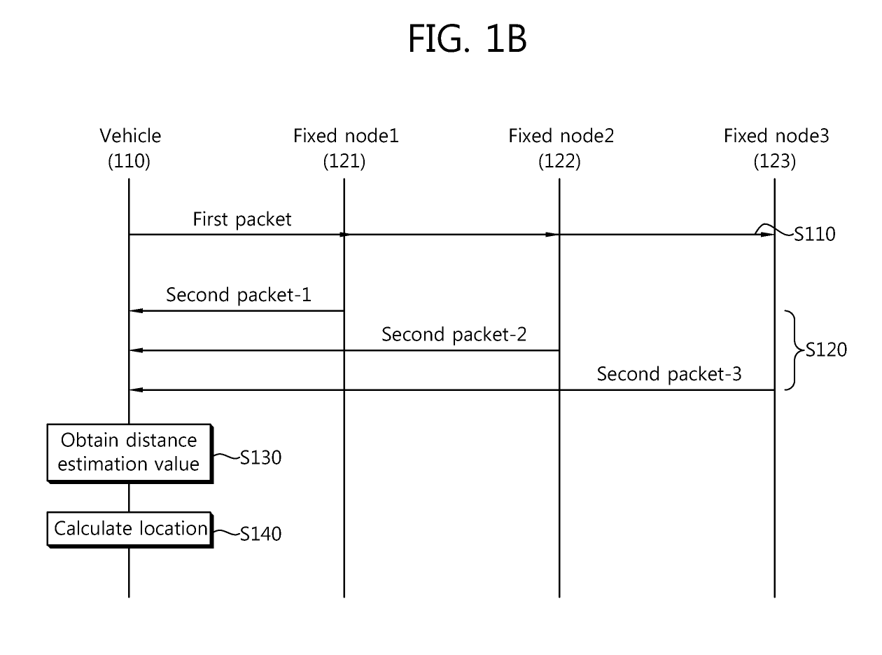

The frequency band used in IR-UWB is divided into three bands: a sub-GHz band, a low band and a high band. Sixteen channels are allocated to the three bands, through which communication can be performed. The sixteen channels may be divided into mandatory channels of channels 0, 3 and 9, and other optional channels. In this case, it is positively necessary to implement one mandatory channel. IR-UWB provided in the IEEE 802.15.4a standard can be applied to location estimation in a stop and/or low-speed movement situation. This will be described in detail with reference to FIG. 1.

FIG. 1 is a view showing an example of location estimation based on an IR-UWB provided in IEEE 802.15.4a standard. The location estimation may be performed based on a triangulation method.

With reference to FIG. 1a, it is assumed that coordinates of a vehicle 110 are (xₘ, yₘ), coordinates of a fixed node 1 121 are (x₁, y₁), coordinates of a fixed node 2 122 are (x₂, y₂), and coordinates of a fixed node 3 123 are (x₃, y₃). Each of the fixed nodes already knows about a two-dimensional (2D) coordinates value indicating its location information. It is assumed that the distances between the vehicle 110 and the fixed nodes 1, 2, and 3 are D1, D2, and D3, respectively.

With reference to FIG. 1b, the vehicle 110 transmits a first packet to the fixed node 1, to the fixed node 2, and to the fixed node 3 (S110). The first packet may be simultaneously transmitted in a broadcast transmission scheme or may be sequentially transmitted to the respective fixed nodes.

The respective fixed nodes 121, 122, and 123 transmit a second packet in response to the first packet (S120). The second packet includes 2D location coordinate information of the respective fixed nodes. Accordingly, the vehicle 110 can obtain a coordinate value indicating the location of each of the fixed nodes.

Upon receiving the second packet, the vehicle 110 obtains the distances D1, D2, and D3 with respect to respective fixed nodes 121, 122, and 123 by using a distance estimation scheme. (S130).

The vehicle 110 may obtain its location through Equation 1 shown below based on the distances D1, D2, and D3 with respect to the respective fixed nodes 121, 122, and 123 and the coordinate values of the respective fixed nodes 121, 122, and 123 (S140).

D₁=\sqrt{(x₁−x_{M})²+(y₁−y_{M})²}

D₂=\sqrt{(x₂−x_{M})²+(y₂−y_{M})²}

D₃=\sqrt{(x₃−x_{M})²+(y₃−y_{M})²} [Equation1]

However, the method for estimating a location of a vehicle through a packet exchange with fixed nodes can obtain an accurate result value in case of a stopped object or when an object moves at a low speed, but if a vehicle is running at a high speed, the reliability of location estimation results in estimating a location through packet exchange with a fixed node is very low. This is not appropriate for an apparatus for providing driving information for a vehicle. Thus, an apparatus and method which can be applicable to a vehicle moving at a high speed in estimating a location by using an IR-UWB device are required.

A high speed movement long distance IR-UWB is an advanced scheme of the existing IR-UWB so as to cover a high speed movement and a long distance situation.

An implementation of a medium access control (MAC) and a physical layer (PHY) of the high speed movement long distance IR-UWB is substantially the same as those for radio communication of the existing IR-UWB, but in comparison, the high speed movement long distance IR-UWB is implemented such that it extends a communication radius by changing a particular parameter and is applicable even for a high speed movement situation. The high speed movement long distance IR-UWB can estimate a distance up to 200 m within a range of 200 km/h, and an error range in the distance estimation is required to be 1 m or shorter. Thus, the high speed movement long distance IR-UWB has such a quite appropriate specification as to be a basis of a distance estimation and location estimation system as part of a vehicle running safety system.

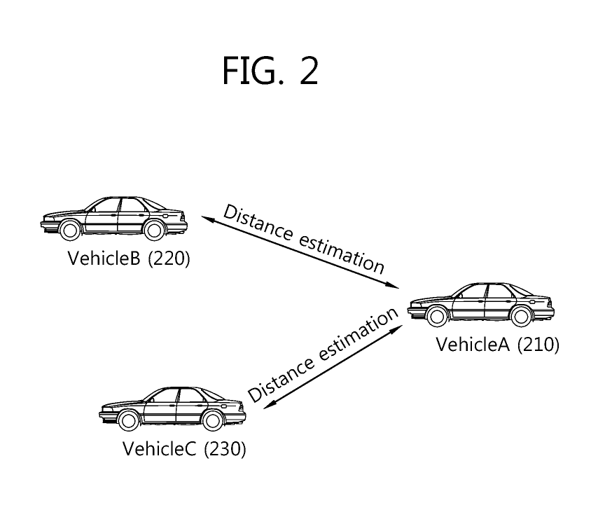

FIG. 2 is view showing a concept of an IR-UWB applicable to an embodiment of the present invention.

With reference to FIG. 2, a vehicle A 210, a vehicle B 220, and a vehicle C 230 support the high speed movement long distance IR-UWB, respectively. Unlike the existing IR-UWB, the high speed movement long distance IR-UWB is a new technique that minimizes a distance estimation error which may be generated due to Doppler effect, or the like, and extends the existing IR-UWB to a high speed running situation by maximizing a distance estimation update period.

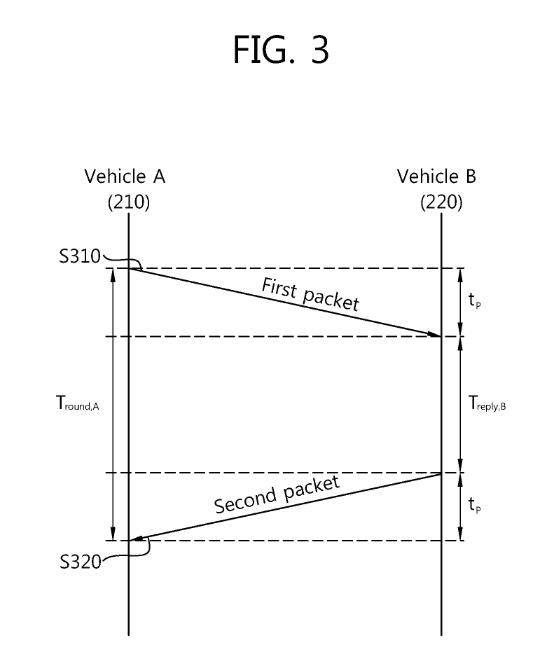

The vehicle A 210 measures a distance with respect to each of the vehicle B 220 and the vehicle C 230 through radio communication based on the high speed movement long distance IR-UWB, respectively. In performing radio communication, the vehicle A 210 may estimate an inter-vehicle distance through a transmission-reception mechanism, and estimate a relative location of the vehicle A 210 with respect to the vehicle B 220 and the vehicle C 230 based on the estimated distance information. The distance estimation method will now be described in detail with reference to FIG. 3.

FIG. 3 is a view showing an example of a method for estimating a distance according to an embodiment of the present invention. A distance estimation method may be performed a time of arrival (TOA) measurement based on two way ranging (TWR).

With reference to FIG. 3, the vehicle A 210 transmits a first packet to the vehicle B 220 (S310). Here, it is assumed that a time (TOA) taken for the first packet to reach the vehicle B 220 after the vehicle A 210 transmits the packet is tₚ. The vehicle B 220 transmits a second packet to the vehicle A 210 in response to the first packet transmission. Here, in general, a time (TOA) taken for the second packet to reach the vehicle A210 after the vehicle B 220 transmits the packet may also be t_{p.}

The vehicle B 220 may know about a time duration T_{reply,B} from a point in time at which the first packet was received and a point in time at which the second packet was transmitted. Thus, when T_{reply,B} is included in the second packet and transmitted to the vehicle A 210, the vehicle A 210 can obtain a corresponding time value.

When the vehicle A 210 calculates a time duration T_{round,A} from a point in time at which the first packet was transmitted and a point in time at which the second packet was received to obtain it, it can obtain the tₚ value as represented by Equation 2 shown below:

$${t}_{p} = \frac{{T}_{round , A} - {T}_{reply , B}}{2} \qquad [ Equation 2 ]$$

The vehicle A 210 obtains tₚ as a TOA value, and since a transfer rate of the packet has a particular value, the vehicle A 210 can obtain the distance to the vehicle B 220. In this manner, the vehicle A 210 can estimate the distance to the vehicle C 220 and a distance to a different vehicle. The distance estimation results may be used as a basis for estimating a relative location of the vehicle A 210 with respect to a different vehicle.

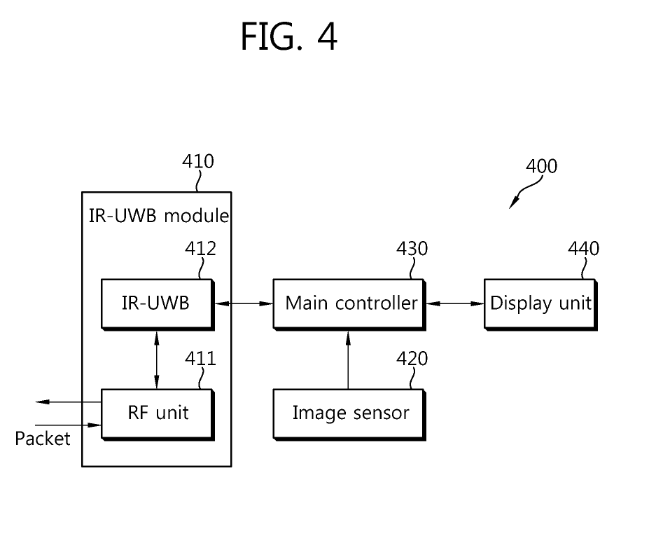

FIG. 4 is a schematic block diagram of an apparatus for providing vehicle driving information based on IR-UWB according to an embodiment of the present invention.

With reference to FIG. 4, apparatus 400 for providing driving information for a vehicle based on IR-UWB includes an IR-UWB module 410, an image sensor 420, a main controller 430, and a display unit 440.

The IR-UWB module 410 includes an RF unit 411 and an IR-UWB modem 412. The RF unit 411 implements a PHY layer for radio communication based on IR-UWB. The RF unit 411 is functionally coupled with the IR-UWB modem 412 to perform a packet transmission and/or reception.

The IR-UWB modem 412 implements a MAC layer for radio communication based on IR-UWB.

The IR-UWB modem 412 can support both the high speed movement long distance IR-UWB and the short-range IR-UWB. The IR-UWB modem 412 generates a packet to be transmitted for estimating a distance through a packet exchange with a different vehicle.

Also, when the IR-UWB modem 412 receives a packet, it interprets the received packet to obtain driving information generated by a different vehicle. The running operation may include the results of a distance estimation and results of a location estimation performed by the different vehicle.

In addition, indication information regarding a running state (e.g., the speed of a section, whether or not an accident has happened, or the like) detected by the different vehicle or obtained by receiving running operation from a third vehicle may be further included.

The image sensor 420 obtains short-range location recognition information and transmits the obtained information to the main controller 430. Since a detection range is relatively narrow compared with the IR-UWB module, so the image sensor 420 may measure a location with respect to a different vehicle located near the vehicle to obtain location information.

The main controller 430 may be set to perform a distance estimation and a relative location estimation. The main controller 430 may be set to perform a distance estimation in the same manner as described above with reference to FIG. 3. The main controller 430 may generate driving information based on the distance estimation results and the relative location estimation results transferred from the IR-UWB module 410. The driving information may be stored in the main controller 430 or a memory unit functionally coupled with the main controller 430.

The main controller 430 may compensate for the location estimation results transferred from the IR-UWB module 410 by using short-range vehicle recognition information transferred from the image sensor 420. Accordingly, with respect to a vehicle located within a short distance, very precise location information can be obtained.

The main controller 430 may control the IR-UWB module 410 to perform a packet transmission and/or reception for a distance estimation and a relative location estimation or control the image sensor 420 to obtain short-range location recognition information. Also, the main controller 430 may set to implement the apparatus for providing driving information for a vehicle based on the driving information and the short-range location recognition information obtained from the IR-UWB module 410 and the image sensor 420.

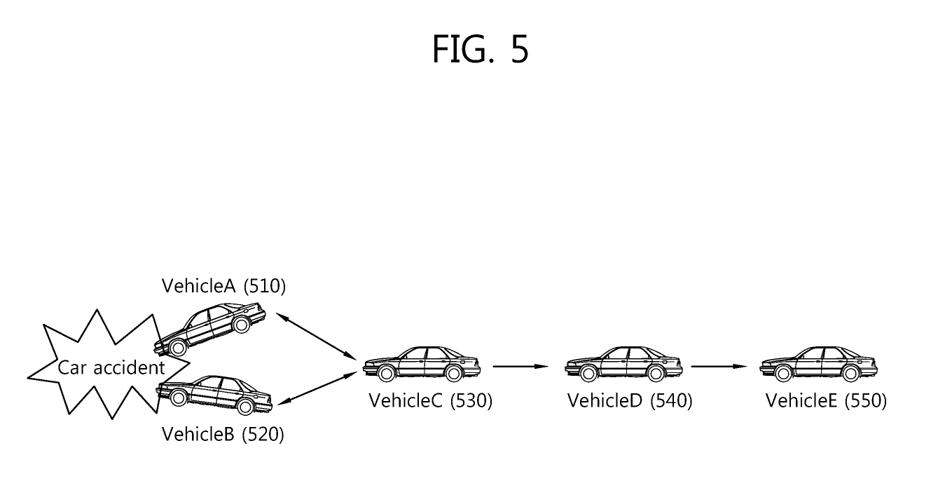

The main controller 430 may be set to packetize driving information received from a different vehicle and driving information directly obtained by itself and transmit the same to a different vehicle. This is called a multi-hop transmission. The multi-hop transmission will now be described with reference to FIG. 5.

With reference to FIG. 5, it is illustrated that a vehicle A 510, a vehicle B 520, a vehicle C 530, a vehicle D 540, and a vehicle E 550 are running at particular distance intervals, and a car accident has happed between the vehicle A 510 and the vehicle B 520.

The vehicle C 530 performs a distance estimation with respect to the vehicle A 510 and the vehicle B 520. The vehicle C 530 may obtain the car accident occurrence information by packet-exchanging with the vehicle A 510 and/or the vehicle B 520. Also, the vehicle C 530 can obtain relative location information of the vehicle A 510 and the vehicle B 520, and also recognize its relative location through the location estimation results.

The vehicle C 530 transmits the accident information and the locations of the vehicle A, the vehicle B 520, and the vehicle C 530 to the vehicle D 540. Likewise, the vehicle D 540 adds its location information to the accident information and the information regarding the respective vehicle locations obtained fro the vehicle C 530, and transmits the same to the vehicle E 550. Through this process, the vehicle E 550 can know about the accident of the vehicle A 510 and the vehicle B 520, and obtain information regarding locations of the vehicle A 510 to the vehicle E 550. Thus, the vehicle E 550 can cope with the accident that happened at a long distance.

With reference to FIG. 4, the main controller 430 is illustrated to be a separate constituent element from the IR-UWB module 410, but this is merely an example, and the IR-UWB module 410 itself may be implemented to perform the function of the main controller 430.

The display unit 440 may be implemented to display information regarding running transferred from the main controller 430 to allow an operator (i.e., driver or a user) to check it. As shown in FIG. 4, the apparatus for providing driving information for a vehicle may include the display unit 440 for displaying information related to running as video, graphic, or the like, in order to provide driving information, but in this case, the apparatus for providing driving information for a vehicle may include a sound unit, which provides the information related to running as a sound, as a substitute or may include both the display unit 440 and the sound unit.

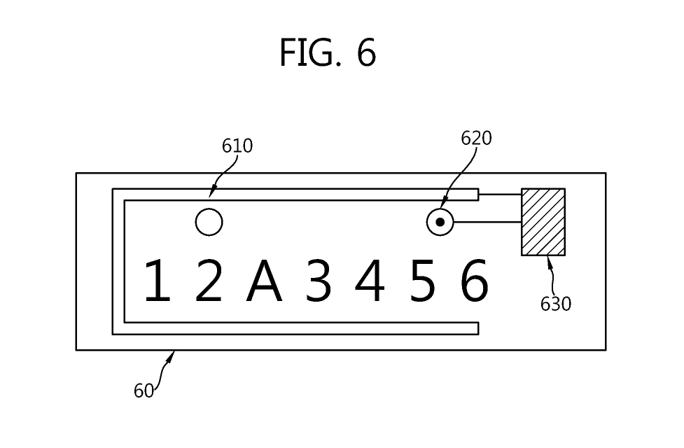

FIG. 6 is a view showing an example of implementation of an apparatus for providing vehicle driving information according to an embodiment of the present invention.

With reference to FIG. 6, the apparatus for providing vehicle driving information may be implemented on a license plate 60. A patch type antenna 610 may be disposed to surround the girth of the license plate and may be driven by the RF unit 411 of the IR-UWB module 410. An image sensor 620 may be installed at a portion where a fixing member for fixing the license plate 60 is installed. The patch type antenna 610 and the image sensor 620 may be functionally coupled with a control module 630 including the IR-UWB modem 412 and the main controller 430 so as to be installed. The control module 630 may include the foregoing IR-UWB modem 412 and the main controller 430, and may be installed at an inner side of the license plate, on the license plate, or at an outer side of the license plate.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

According to embodiments of the present invention, since the apparatus for providing vehicle driving information is implemented based on IR-UWB, a distance estimation function can be implemented at a relatively low cost compared with an existing apparatus.

Since short-range driving information is obtained based on IR-UWB and an image sensor, a distance can be precisely estimated and a relative location can be estimated.

Driving information from a vehicle is received and then transmitted to a different vehicle, thus guaranteeing high security and safety of vehicle driving.

What is claimed is:

1. An apparatus for providing driving information for a vehicle based on high speed movement long distance impulse radio-ultra wideband (IR-UWB), the apparatus comprising:
an IR-UWB module configured to generate a packet based on high speed movement long distance IR-UWB, transmit the generated packet, and interpret a received packet; and
a controller operationally coupled to the IR-UWB module,
wherein the controller is configured for:
estimating a distance between an own vehicle and a different vehicle;
estimating a relative location of the own vehicle with respect to the different vehicle based on the distance; and
generating driving information including the distance and the relative location.

2. The apparatus of claim 1, wherein the controller is configured for:
transmitting the driving information to a third vehicle.

3. The apparatus of claim 1, further comprising:
an image sensor is operationally coupled to the controller,
wherein the image sensor is configured for:
measuring location of the different vehicle when the different vehicle exists within a predetermined detection range.

4. The apparatus of claim 3, wherein the controller is configured for:
compensating for the distance based on location measurement results of the different vehicle when the location measurement results are received from the image sensor,
wherein the driving information comprises the compensated distance and the relative location.

5. The apparatus of claim 1, further comprising:
a display unit operationally coupled with the controller,
wherein the display unit is configured to visually display the driving information transferred from the controller.

6. The apparatus of claim 1, wherein the estimating of the distance includes:
transmitting a first packet to the different vehicle;
receiving a second packet from the different vehicle in response to the first packet; and,
calculating the distance based on a time taken for the first packet to reach the different vehicle after the first packet was transmitted.

7. The apparatus of claim 1, wherein the apparatus for providing driving information for a vehicle is installed on a license plate.

8. A method for providing driving information for a vehicle, the method comprising:
estimating a distance between an own vehicle and a different vehicle;
estimating a relative location of the own vehicle with respect to the different vehicle based on the distance; and
generating driving information including the distance and the relative location,
wherein the distance is estimated based on a packet transmission and reception based on high speed movement long distance impulse radio-ultra wideband (IR-UWB).

9. The method of claim 8, further comprising:
transmitting the driving information to a third vehicle.

10. The method of claim 8, further comprising:
when the different vehicle exists within a predetermined range, measuring a location of the different vehicle and compensating for the distance based on the location of the different vehicle,
wherein the driving information includes the distance and the relative location.

11. The method of claim 8, wherein the estimating of the distance includes transmitting a first packet to the different vehicle, receiving a second packet from the different vehicle in response to the first packet, and calculating the distance based on a time taken for the first packet to reach the different vehicle after the first packet was transmitted.

12. The method of claim 8, further comprising:
visually displaying the driving information.
